(19) United States
(12) Patent Application Publication
(10) Pub. No.: US 2025/0262854 A1
(43) Pub. Date: Aug. 21, 2025

(54) INKJET RECORDING APPARATUS AND METHOD FOR CONTROLLING INKJET RECORDING APPARATUS

(71) Applicant: Konica Minolta, Inc., Tokyo (JP)

(72) Inventor: Hiroaki OKANO, Tokyo (JP)

(21) Appl. No.: 19/055,664

(22) Filed: Feb. 18, 2025

(30) Foreign Application Priority Data
Feb. 19, 2024 (JP) 2024-023005

(51) Int. Cl. B41J 2/045; B41J 2/21

(52) U.S. Cl. CPC B41J 2/0456; B41J 2/0451; B41J 2/04531; B41J 2/04541; B41J 2/04581; B41J 2/04588; B41J 2/2128

(57) ABSTRACT

Disclosed is an inkjet recording apparatus including: a head that includes a plurality of nozzles configured to eject ink onto a recording medium; a drive waveform generator that generates drive waveforms to drive the respective plurality of nozzles; a reverberation waveform receiver that acquires reverberation waveforms generated in the respective plurality of nozzles to be measured in accordance with the drive waveforms; and a hardware processor that generates a characteristic distribution of the acquired reverberation waveforms and performs, based on the characteristic distribution, an ejection characteristic control process of controlling an ejection characteristic of the plurality of nozzles to be uniform.

### CROSS-REFERENCE TO RELATED APPLICATIONS

The present invention claims priority under 35 U.S.C. § 119 to Japanese Application No. 2024-023005 filed Feb. 19, 2024, the entire content of which is incorporated herein by reference.

### BACKGROUND OF THE INVENTION

### Technical Field

The present invention relates to an inkjet recording apparatus and a method for controlling an inkjet recording apparatus.

### Description of Related Art

In an inkjet recording apparatus, an inkjet head forms an image by ejecting ink droplets from a plurality of nozzles. In order to obtain high image quality, it is important to suitably control the ejection characteristics such as the ejection speed and ejected droplet amount of the nozzles. The ejection characteristics of the nozzles vary with the temperature of ink adjacent to the nozzles. Therefore, by stably maintaining the ink temperature, the ink ejection characteristics can be stably maintained. In order to keep the temperature adjacent to the nozzle constant, the ink temperature is generally adjusted by using a temperature sensor and a heater disposed within the inkjet head. As a technique for adjusting the ink temperature inside the inkjet head, a technique described in JP 2004-306529A is disclosed, for example.

It is described in JP 2004-306529A that residual vibration of a vibration plate is detected. Furthermore, a temperature detection means is described which detects the temperature of a liquid in a cavity of a droplet ejection head based on a vibration pattern of the detected residual vibration of the vibration plate. Furthermore, it is described that the temperature of the liquid in the cavity is adjusted based on the ambient temperature of the droplet ejection head detected by a temperature sensor and a detection value of the temperature detection means.

### SUMMARY OF THE INVENTION

As described above, conventionally, there has been disclosed a technique (JP 2004-306529A) of adjusting the temperature of a liquid in a cavity based on the ambient temperature of a head detected by a temperature sensor and the temperature of the liquid in the cavity detected based on residual vibration of a vibration plate. However, since the ink temperature inside an inkjet head has a temperature difference distribution, the ink temperature adjacent to each nozzle is different. The technology described in JP 2004-306529A does not consider the temperature difference distribution of the ink temperature inside an inkjet head. However, in order to obtain higher image quality, it is necessary to uniformly control the ejection characteristics of each nozzle by adjusting the ink temperature adjacent to each nozzle.

The present invention has been made in consideration of the above-described situation, and objects of the present invention include uniformly controlling the ejection characteristics of each nozzle of a head.

To achieve at least one of the abovementioned objects, according to one aspect of the present invention, an inkjet recording apparatus comprises: a head that includes a plurality of nozzles configured to eject ink onto a recording medium; a drive waveform generator that generates drive waveforms to drive the respective plurality of nozzles; a reverberation waveform receiver that acquires reverberation waveforms generated in the respective plurality of nozzles to be measured in accordance with the drive waveforms; and a hardware processor that generates a characteristic distribution of the acquired reverberation waveforms and performs, based on the characteristic distribution, an ejection characteristic control process of controlling an ejection characteristic of the plurality of nozzles to be uniform.

To achieve at least one of the abovementioned objects, according to another aspect of the present invention, a method for controlling an inkjet recording apparatus that includes a head including a plurality of nozzles configured to eject ink onto a recording medium comprises: generating drive waveforms to drive the respective plurality of nozzles; acquiring reverberation waveforms generated in the respective plurality of nozzles to be measured in accordance with the drive waveforms; and generating a characteristic distribution of the acquired reverberation waveforms to perform, based on the characteristic distribution, an ejection characteristic control process of controlling an ejection characteristic of the plurality of nozzles to be uniform.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating an overall configuration of an inkjet recording apparatus according to a first embodiment of the present invention;

FIG. 2 is a block diagram illustrating a functional configuration of a control system of the inkjet recording apparatus according to the first embodiment of the present invention;

FIG. 3 is a block diagram illustrating a configuration of a control circuit in the inkjet recording apparatus according to the first embodiment of the present invention;

FIG. 4 is a block diagram illustrating a configuration of a reverberation waveform measurement circuit in the inkjet recording apparatus according to the first embodiment of the present invention;

FIG. 5 is a diagram illustrating a reverberation waveform acquired from a nozzle;

FIG. 6 is a diagram illustrating amplitude distributions of reverberation waveforms;

FIG. 7 is a diagram illustrating a procedure of an initialization process of the inkjet recording apparatus according to the first embodiment of the present invention;

FIG. 8 is a diagram illustrating a procedure of an in-printing control process of the inkjet recording apparatus according to the first embodiment of the present invention;

FIG. 9 is a diagram illustrating a procedure of an ejection characteristic control process of the inkjet recording apparatus according to the first embodiment of the present invention;

FIG. 10 is a diagram illustrating data of a drive voltage correction table of the inkjet recording apparatus according to a second embodiment of the present invention; and

FIG. 11 is a diagram illustrating a procedure of an ejection characteristic control process of the inkjet recording apparatus according to the second embodiment of the present invention by drive voltage adjustment.

### DETAILED DESCRIPTION

Hereinafter, one or more embodiments of the present invention will be described with reference to the drawings. However, the scope of the invention is not limited to the disclosed embodiments.

In the present specification and drawings, constituent elements having substantially the same function or configuration are denoted by the same reference numerals, and redundant descriptions of the constituent elements are omitted.

### First Embodiment

### [Configuration of Inkjet Recording Apparatus]

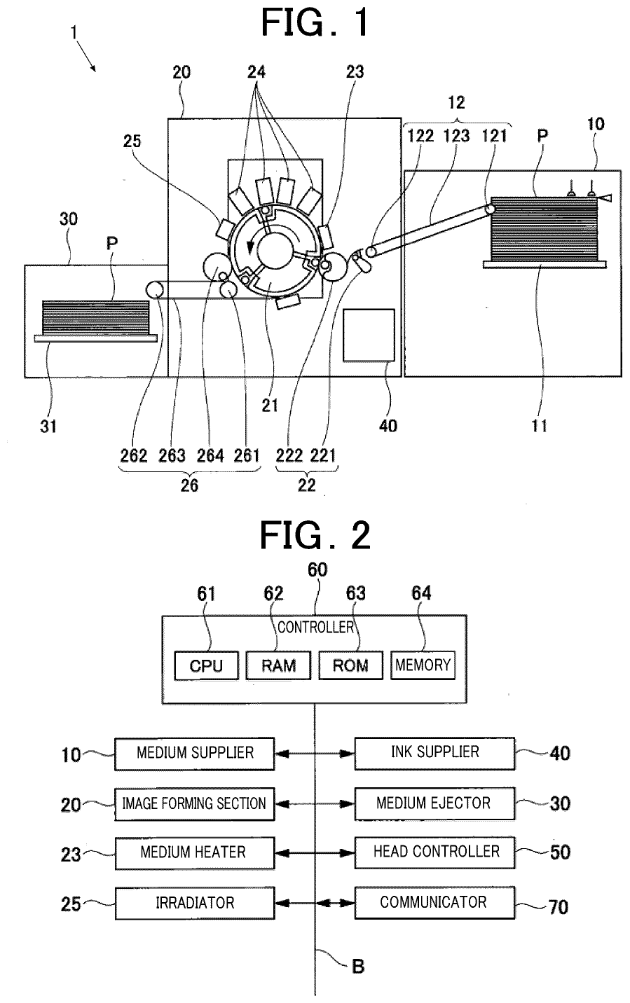

First, a configuration of an inkjet recording apparatus 1 according to a first embodiment of the present invention will be described. FIG. 1 is a diagram illustrating an overall configuration of an inkjet recording apparatus 1 according to the present embodiment. As illustrated in FIG. 1, the inkjet recording apparatus 1 includes a medium supplier 10, an image forming section 20, a medium ejector 30, and an ink supplier 40. The inkjet recording apparatus 1 conveys a recording medium P stored in the medium supplier 10 to the image forming section 20 under control of a controller 60 described later. The inkjet recording apparatus 1 also forms (prints) an image on the recording medium P in the image forming section 20 and ejects the recording medium P having the image printed thereon to the medium ejector 30.

### (1) Medium Supplier

The medium supplier 10 includes a supply tray 11 that stores the recording medium P and a conveyer 12 that conveys the recording medium P from the supply tray 11 to the image forming section 20. Note that various media that can be held curved on the outer peripheral surface of an image forming drum 21 described later are used as the recording medium P. As the recording medium P, printing sheet (paper), a cell, a film, a textile, or the like can be used, for example. Hereinafter, the recording medium P may be referred to as “sheet”.

The supply tray 11 is a plate-shaped member on which one or a plurality of recording media P can be placed. The supply tray 11 is disposed so as to move up and down in accordance with the amount of the recording media P placed on the supply tray 11. The supply tray 11 holds the uppermost recording medium P in the up-down direction at a position to be conveyed by the conveyer 12.

The conveyer 12 includes a plurality of rollers, for example, a roller 121 and a roller 122, and a belt 123. Furthermore, the conveyer 12 includes a conveyance mechanism (not illustrated) and a supplier (not illustrated). The circular belt 123 is a circular belt stretched by the roller 121 and the roller 122. The conveyance mechanism drives the belt 123 to convey the recording medium P on the belt 123. The supplier passes the uppermost recording medium P placed on the supply tray 11 onto the belt 123. The conveyer 12 conveys the recording medium P passed by the supplier onto the belt 123 in a direction from the roller 121 to the roller 122.

### (2) Image Forming Section

The image forming section 20 includes an image forming drum 21, a passing unit 22, a medium heater 23, a plurality of head units 24, an irradiator 25, and a delivery unit 26.

The image forming drum 21 is formed of a cylindrical member and rotates counterclockwise in the drawing by a drive motor (not illustrated). The image forming drum 21 holds the recording medium P along its cylindrical outer peripheral surface and rotates to convey the recording medium P. The medium heater 23, the plurality of head units 24, and the irradiator 25 are disposed on the conveyance surface of the image forming drum 21. The medium heater 23, the head units 24, and the irradiator 25 perform an image formation process on the recording medium P conveyed by the image forming drum 21.

As illustrated in FIG. 1, the passing unit 22 is disposed between the conveyer 12 of the medium supplier 10 and the image forming drum 21. The passing unit 22 includes a claw 221 that holds one end of the recording medium P conveyed by the conveyer 12. Furthermore, the passing unit 22 includes a cylindrical passing drum 222 that guides the recording medium P held by the claw 221 to the image forming drum 21. The claw 221 picks up the recording medium P, guides the recording medium P along the outer peripheral surface of the passing drum 222 to pass the recording medium P to the image forming drum 21.

The medium heater 23 includes, for example, an electric heating wire and generates heat in response to energization. The medium heater 23 is disposed adjacent to the outer peripheral surface of the image forming drum 21 and upstream of the head units 24 in a conveyance direction of the recording medium P. The medium heater 23 heats the recording medium P, which is held by the image forming drum 21 and passes adjacent to the medium heater 23, to a predetermined temperature.

Each of the head units 24 includes a plurality of inkjet heads (not shown). Each inkjet head has a plurality of nozzles for ejecting ink onto the recording medium P. The head unit 24 causes the nozzles to eject ink droplets onto the recording surface of the recording medium P at appropriate timings, thereby forming an image on the recording surface of the recording medium P. Hereinafter, the inkjet head is abbreviated as a “head”.

The irradiator 25 irradiates the recording medium P with energy rays to cure the ink. The irradiator 25 includes, for example, a fluorescent tube, such as a low-pressure mercury lamp, and causes the fluorescent tube to emit light to radiate energy rays, such as ultraviolet rays. The irradiator 25 is disposed adjacent to the outer peripheral surface of the image forming drum 21 and downstream of the head units 24 in the conveyance direction of the recording medium P.

The delivery unit 26 delivers the recording medium P, which has been irradiated with the energy rays by the irradiator 25, from the image forming drum 21 to the medium ejector 30. The delivery unit 26 includes a plurality of rollers, for example, a roller 261 and a roller 262, and a belt 263. The delivery unit 26 also includes a conveyance mechanism (not illustrated) and a passing drum 264. The belt 263 is a circular belt stretched by the roller 261 and the roller 262. The conveyance mechanism drives the belt 263 to convey the recording medium P on the belt 263. The passing drum 264 is a cylindrical drum that passes the recording medium P from the image forming drum 21 to the conveyance mechanism. The delivery unit 26 conveys the recording medium P passed to the belt 263 by the passing drum 264 through the belt 263, sending the recording medium P to the medium ejector 30.

### (3) Medium Ejector

The medium ejector 30 stores the recording medium P sent from the image forming section 20 by the delivery unit 26. The medium ejector 30 includes a plate-shaped ejection tray 31, and the like. The recording medium P on which an image has been formed is placed on the ejection tray 31.

### (4) Ink Supplier

The ink supplier 40 stores ink of each color used for recording an image and supplies the ink to the corresponding head unit 24 of the image forming section 20. The ink supplier 40 may be disposed in any manner. For example, the ink supplier 40 is disposed in a dedicated rack or the like and is coupled to the image forming section 20 via a pipe material such as a tube. The ink supplied to each head unit 24 of the image forming section 20 is ejected from the nozzles of the heads.

FIG. 2 is a block diagram illustrating a functional configuration of a control system of the inkjet recording apparatus 1 according to the present embodiment. The inkjet recording apparatus 1 includes a head controller 50 (hardware processor), a controller 60, and a communicator 70, as illustrated in FIG. 2, in addition to the various components described in FIG. 1. Each component is coupled by a bus B so as to be able to transmit and receive information data to and from each other.

The head controller 50 drives each of the nozzles in order to suitably eject ink from the nozzles of each of the heads in the head unit 24. The head controller 50 selects, based on a control signal from the controller 60, a drive waveform pattern for printing stored in advance. In addition, the head controller 50 generates a drive signal to drive the nozzle in accordance with the selected drive waveform pattern for printing. Further, the head controller 50 switches whether to output the drive signal to each nozzle according to image data to be printed. Hereinafter, the drive signal is also referred to as a “drive waveform”.

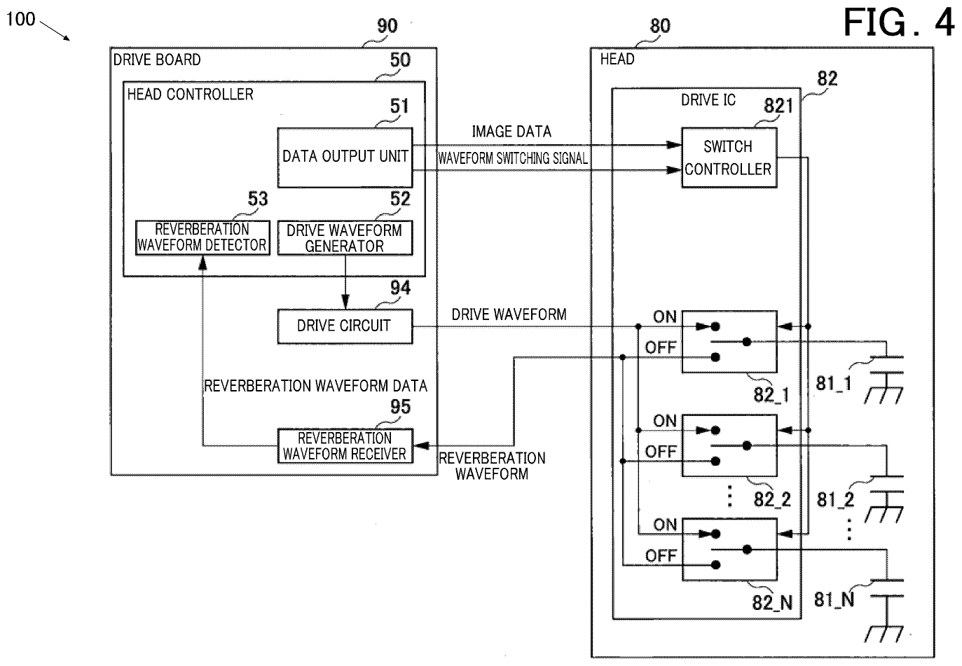

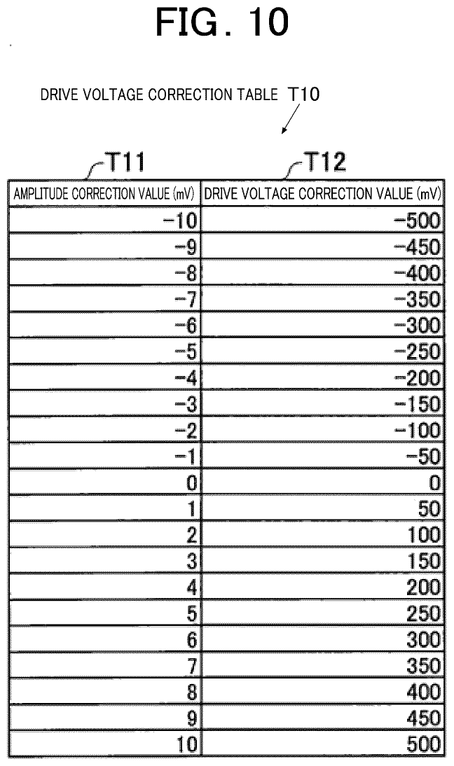

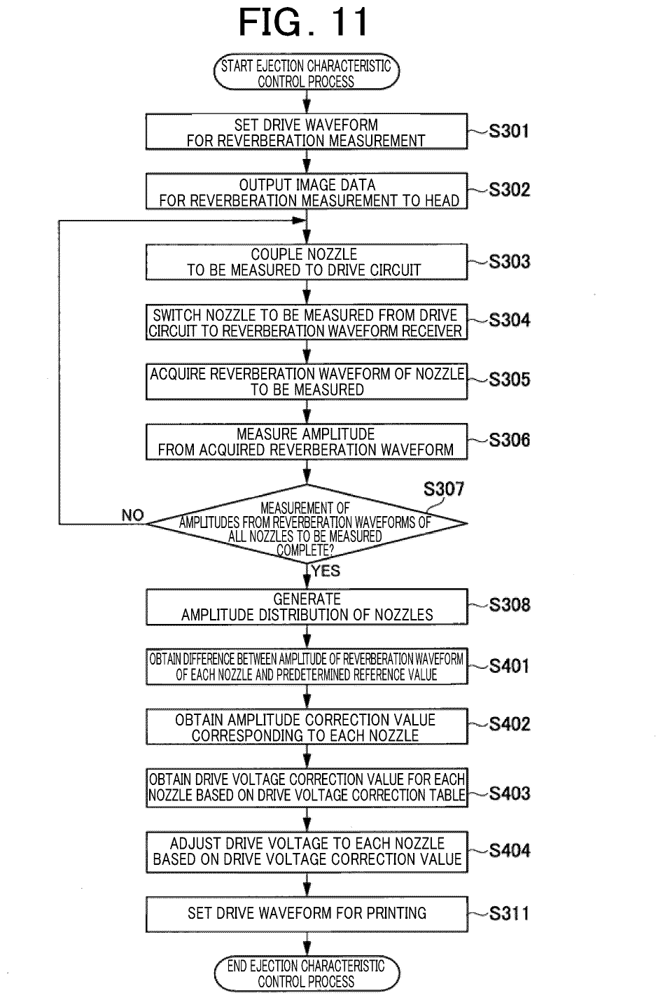

In addition, the head controller 50 acquires a waveform of residual vibration generated after each of the plurality of nozzles included in the head is driven. Hereinafter, the waveform of the residual vibration is referred to as a “reverberation waveform”. The reverberation waveform is measured and acquired by a residual vibration measurement circuit 100 illustrated in FIG. 4 to be described later. The head controller 50 generates a characteristic distribution of the acquired reverberation waveforms and performs an ejection characteristic control process of controlling the ejection characteristics of the plurality of nozzles to be uniform based on the characteristic distribution. Here, the characteristic distribution is, for example, an amplitude distribution of the reverberation waveforms. The ejection characteristics include at least one of the ejection speed and ejected droplet amount of the nozzle. The ejection characteristic control process will be described in detail later with reference to FIG. 10 and FIG. 11.

The controller 60 comprehensively controls the overall operation of the inkjet recording apparatus 1. The controller 60 includes a central processing unit (CPU 61), a random-access memory (RAM 62), a read only memory (ROM 63), and a memory 64.

The CPU 61 performs the image formation process, the ejection characteristic control process, and the like in the inkjet recording apparatus 1 in accordance with programs read from the ROM 63.

The RAM 62 includes a storage media such as a volatile memory, for example, and temporarily stores information (data) required for each process performed by the CPU 61.

The ROM 63 includes, for example, a storage media such as a nonvolatile memory and stores programs, data, and the like that the CPU 61 executes and refers to. The ROM 63 is used as an example of non-transitory computer-readable storage media storing the programs to be executed by the controller 60. The memory 64 is an image memory that temporarily stores image data to be recorded, or the like.

The communicator 70 is a communication interface that controls a communication operation with an external device. Examples of the communication interface include a plurality of interfaces compatible with various communication protocols, such as a LAN board and a LAN card. The communicator 70 acquires the image data to be recorded and setting data (print job) related to image recording from the external device under the control of the controller 60.

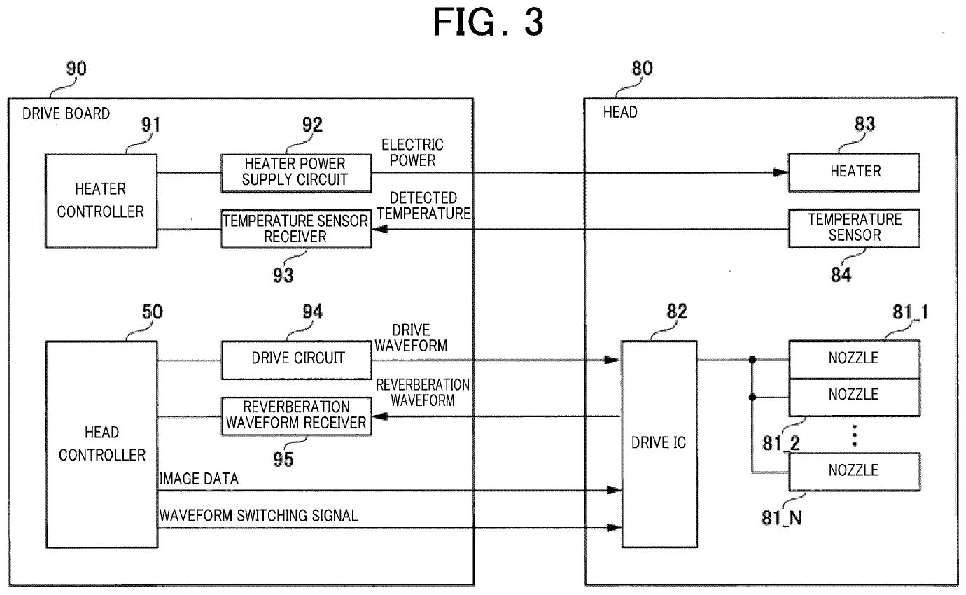

Next, a configuration of a control circuit in the inkjet recording apparatus 1 will be described. FIG. 3 is a block diagram illustrating the configuration of the control circuit in the inkjet recording apparatus 1 according to the present embodiment. As illustrated in FIG. 3, the control circuit in the inkjet recording apparatus 1 includes the heads 80 of the head unit 24 and a drive board 90. Only one of the heads 80 is shown in FIG. 3. In practice, all the plurality of heads 80 of the head unit 24 is coupled to the drive board 90 as illustrated in FIG. 3.

As illustrated in FIG. 3, the head 80 includes a plurality of nozzles (nozzles 81_1 to 81_N) and a drive integrated circuit (IC) 82. The head 80 also includes a heater 83 and a temperature sensor 84. Each of the nozzles is coupled to the drive IC 82. The heater 83, the temperature sensors 84, and the drive IC 82 are each coupled to the drive board 90.

The drive IC 82 receives a drive waveform for driving the nozzle, image data, and a waveform switching signal from the head controller 50 disposed on the drive board 90. The drive IC 82 outputs the drive waveform to a target nozzle in accordance with the image data and the waveform switching signal to drive the target nozzle. The heater 83 is supplied with electric power from a heater power supply circuit 92 (described later) on the drive board 90 and increases the temperature of a carriage (not illustrated) in the head 80 to a predetermined temperature. Here, the predetermined temperature can be suitably set within a temperature range in which the ink can be ejected. The temperature sensor 84 detects the temperature of the carriage and outputs the detected temperature to a temperature sensor receiver 93 (described later) on the drive board 90. The temperature sensor 84 includes, for example, a thermistor.

As illustrated in FIG. 3, the drive board 90 includes a heater controller 91, a heater power supply circuit 92, and a temperature sensor receiver 93. The drive board 90 also includes the head controller 50, a drive circuit 94, and a reverberation waveform receiver 95.

The heater controller 91 includes, for example, a CPU or the like and controls operations of the heater power supply circuit 92 and the temperature sensor receiver 93. The heater power supply circuit 92 supplies electric power to the heater 83 in the head 80 under the control of the heater controller 91. The temperature sensor receiver 93 receives the detected temperature from the temperature sensor 84 in the head 80 under the control of the heater controller 91. The heater controller 91 adjusts the output power of the heater power supply circuit 92 based on the detected temperature received by the temperature sensor receiver 93.

In the present embodiment, the head controller 50, the drive circuit 94, the reverberation waveform receiver 95, and the drive IC 82 and the plurality of nozzles of the head 80 illustrated in FIG. 3 constitute a residual vibration measurement circuit 100 (refer to FIG. 4).

FIG. 4 is a block diagram illustrating a configuration of the residual vibration measurement circuit 100 in the inkjet recording apparatus 1 according to the present embodiment. The head controller 50 includes a field programmable gate array (FPGA) or the like. The head controller 50 generates and outputs a drive waveform for driving a piezoelectric element (not illustrated) in order to cause each nozzle of the head 80 to suitably eject ink. As illustrated in FIG. 4, the head controller 50 includes a data output unit 51, a drive waveform generator 52, and a reverberation waveform detector 53 common to the plurality of nozzles.

The data output unit 51 selects image data registered in advance and outputs the image data to a switch controller 821 (described later) of the head 80. In addition, the data output unit 51 outputs a waveform switching signal indicating an output timing of the drive waveform to the switch controller 821 of the head 80.

The drive waveform generator 52 selects a pattern of the drive waveform registered in advance, generates the drive waveform for driving the nozzle, and outputs the drive waveform to the drive circuit 94.

The reverberation waveform detector 53 is common to the plurality of nozzles and receives the reverberation waveforms acquired by the reverberation waveform receiver 95. Furthermore, the reverberation waveform detector 53 generates a characteristic distribution of the received reverberation waveforms and determines whether there is a defective nozzle based on the characteristic distribution. In the present embodiment, the head controller 50 excludes a nozzle determined to be a defective nozzle by the reverberation waveform detector 53 from the target of the ejection characteristic control process. Note that the determination of a defective nozzle based on the characteristic distribution (amplitude distribution) will be described later with reference to FIG. 6.

The drive circuit 94 receives the drive waveform generated by the drive waveform generator 52 and applies the drive waveform to the nozzle via the drive IC 82 (described later) of the head 80 to drive the nozzle.

The reverberation waveform receiver 95 includes an analog-to-digital (AD) converter or the like. The reverberation waveform receiver 95 acquires a reverberation waveform generated in a nozzle and converts the waveform into a digital signal. Furthermore, the reverberation waveform receiver 95 outputs the reverberation waveform converted into the digital signal to the reverberation waveform detector 53 of the head controller 50.

The head 80 includes, for example, the plurality of nozzles of the nozzles 81_1 to 81_N. The drive IC 82 includes the same number of two-channel switches (switches 82_1 to 82_N) as the number of the nozzles. The output side of each of the two-channel switches is coupled to the corresponding nozzle. The ON-side input terminal of the switch is coupled to the output side of the drive circuit 94 on the drive board 90. The OFF-side input terminal of the switch is coupled to the input side of the reverberation waveform receiver 95 on the drive board 90. When the switch is set to the ON-side, the corresponding nozzle coupled to the switch is driven by the drive waveform. When the switch is set to the OFF-side, the reverberation waveform generated in the corresponding nozzle coupled to the switch is acquired by the reverberation waveform receiver 95.

The switch controller 821 receives the image data and the waveform switching signal from the data output unit 51 of the head controller 50. Furthermore, the switch controller 821 is coupled to each of the two-channel switches and controls the ON/OFF operation of the switch according to the image data and the waveform switching signal. When a nozzle is to be driven, the corresponding switch coupled to the nozzle to be driven is set to ON. When a reverberation waveform is to be acquired, the corresponding switch coupled to the nozzle whose reverberation waveform is to be acquired is switched from ON to OFF. In this case, the switches coupled to the nozzles other than the acquisition target remain OFF. The reverberation waveform receiver 95 acquires a reverberation waveform generated after the drive waveform of the nozzle to be measured is turned off, and outputs the reverberation waveform to the reverberation waveform detector 53.

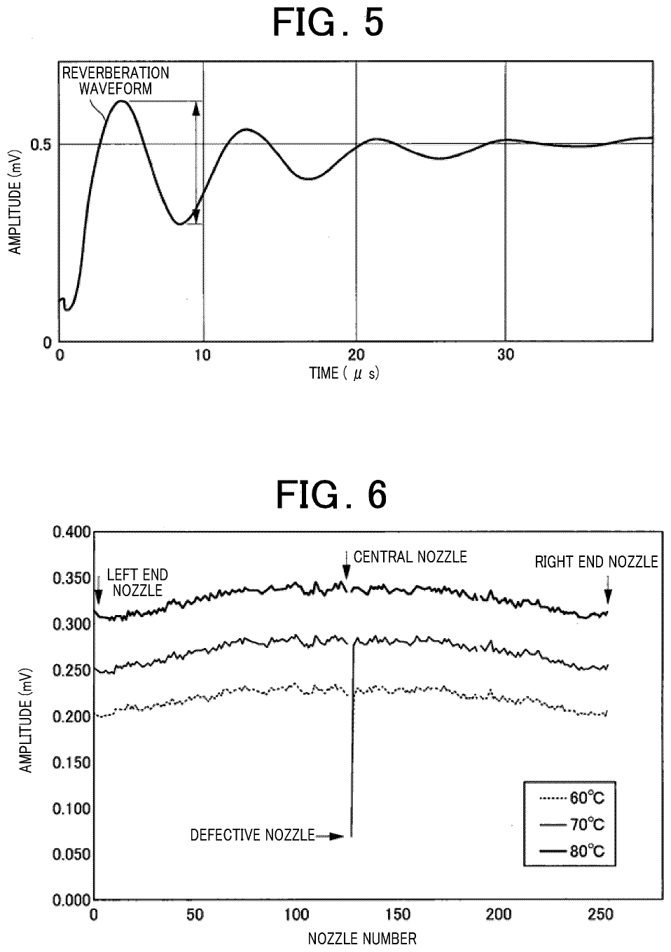

FIG. 5 is a diagram illustrating a reverberation waveform acquired from a nozzle; The horizontal axis of FIG. 5 represents time, for example, in microseconds (μs). The vertical axis of FIG. 5 represents the amplitude of the reverberation waveform, for example, in millivolts (mV). As illustrated in the drawing, the reverberation waveform is composed of a sine wave. The peak-to-peak value of the first wave of a reverberation waveform is the amplitude of the reverberation waveform. The amplitude of the reverberation waveform changes according to the temperature of the nozzle from which the reverberation waveform is acquired. When the temperature of the nozzle is high, the amplitude of the reverberation waveform is large. When the temperature of the nozzle is low, the amplitude of the reverberation waveform is small. That is, an amplitude distribution of reverberation waveforms of the respective nozzles has the same distribution as a temperature distribution adjacent to the nozzles. Uniformly controlling the amplitude of a reverberation waveform of each nozzle means uniformly controlling the temperature adjacent to the nozzle. Therefore, by uniformly controlling the amplitude of a reverberation waveform of each nozzle, it is possible to uniformly control the ejection characteristics of each nozzle.

Note that in the head 80, there is a temperature distribution adjacent to the nozzles depending on, for example, the disposed position of the heater 83 and operating conditions of the components around the nozzles. Due to this temperature distribution, the temperature of each of the nozzles is different. Here, the temperature distribution adjacent to the nozzles is such that the temperature adjacent to the nozzle at the center position is the highest, while the temperature adjacent to the nozzles at both end positions is the lowest. Amplitude distributions of reverberation waveforms of the respective nozzles in this case are illustrated in FIG. 6. FIG. 6 is a diagram illustrating the amplitude distributions of the reverberation waveforms.

The horizontal axis of FIG. 6 represents a nozzle number indicating the position of each nozzle of the head 80. The vertical axis of FIG. 6 represents the amplitude of the reverberation waveform, for example, in millivolts (mV). FIG. 6 illustrates the amplitude distributions (characteristic distributions) of the reverberation waveforms when the heating temperature of the heater 83 is set to 60° C., 70° C., and 80° C. As illustrated in the drawing, the higher the heating temperature of the heater 83, the higher the overall value of each amplitude distribution of the reverberation waveforms. Furthermore, the amplitude distribution of the reverberation waveforms has the same characteristics as the temperature distribution adjacent to the nozzles, and the amplitude at the central position is the highest and the amplitude at the end positions is the lowest.

In the present embodiment, the reverberation waveform detector 53 determines a defective nozzle based on an amplitude distribution of reverberation waveforms. The reverberation waveform detector 53 determines a defective nozzle, for example, based on the amplitude distribution of the reverberation waveforms illustrated in FIG. 6. In this case, as illustrated in FIG. 6, a nozzle corresponding to a position (nozzle number) where there is no amplitude in the amplitude distribution of the reverberation waveforms is determined to be a defective nozzle.

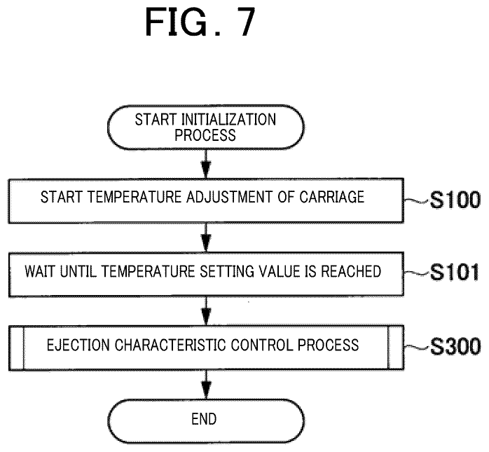

Note that the ejection characteristics, such as the ejection speed and ejected droplet amount of a nozzle, change with temperature. That is, when the temperature of each nozzle is different, the ejection characteristics of each nozzle are different, and the ejection characteristics of each nozzle cannot be uniformly maintained. Since the degree of uniformity of the ejection characteristics of the nozzles is linked to the image quality of a printed image, it is important to uniformly maintain the ejection characteristics of the nozzles in order to achieve high image quality. In the present embodiment, the ejection characteristic control process is performed based on the amplitude distribution of the reverberation waveforms so that the ejection characteristics of the nozzles become uniform. Hereinafter, the control process of the inkjet recording apparatus 1 will be described with reference to FIGS. 7 to FIG. 11.

### [Procedure of Initialization Process of Inkjet Recording Apparatus]

First, an initialization process of the inkjet recording apparatus 1 will be described. FIG. 7 is a diagram illustrating a procedure of the initialization process of the inkjet recording apparatus 1 according to the present embodiment. The process described below is started when the inkjet recording apparatus 1 is activated.

First, the controller 60 of the inkjet recording apparatus 1 starts temperature adjustment of the carriage (S100). The head 80 and the drive board 90 are mounted on the carriage. In this step, the controller 60 outputs an instruction to start the temperature adjustment to the heater controller 91 of the drive board 90. The heater controller 91 controls the output power of the heater power supply circuit 92 to adjust the temperature inside the head 80 according to the instruction of the controller 60.

Next, the controller 60 causes each component of the carriage to wait until the temperature of the component reaches a temperature setting value for performing the printing operation (S101). In addition, in this step, when the temperature of each component of the carriage reaches the temperature setting value, the controller 60 outputs an instruction to start the process to the head controller 50.

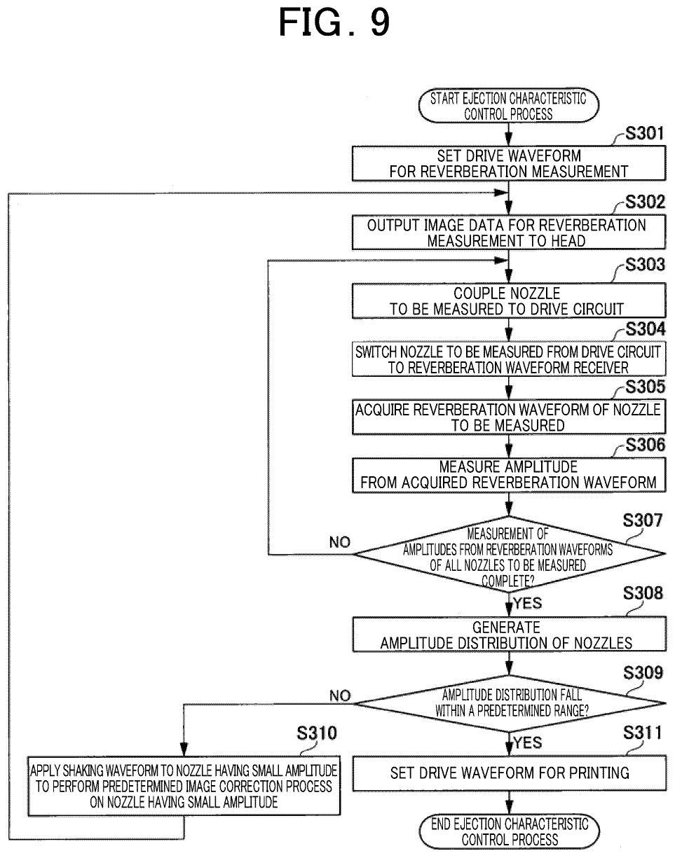

Next, the head controller 50 performs the ejection characteristic control process (S300). That is, the head controller 50 performs the ejection characteristic control process in the initialization process performed when the inkjet recording apparatus 1 is activated. After the process of S300, the controller 60 ends the initialization process. Note that the ejection characteristic control process will be described in detail later with reference to FIG. 9.

### [Procedure of In-Printing Control Process of Inkjet Recording Apparatus]

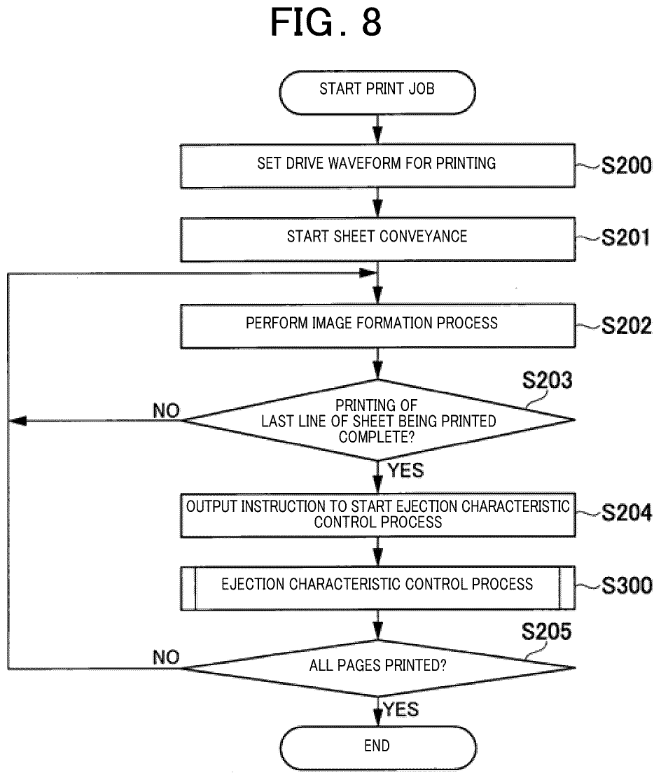

First, an in-printing control process of the inkjet recording apparatus 1 will be described. FIG. 8 is a diagram illustrating a procedure of the in-printing control process of the inkjet recording apparatus 1 according to the present embodiment. The process described below is started when a print job is executed.

First, the head controller 50 selects and sets, based on a control signal from the controller 60, a drive waveform pattern for printing stored in advance (S200).

Next, the controller 60 controls the medium supplier 10 to start sheet conveyance (S201).

Next, the controller 60 controls each component to perform the image formation process (S202).

Next, the controller 60 determines whether printing of the last line of a sheet being printed is complete (S203). That is, the controller 60 determines whether the current time falls in the interval between the printing times of pages being printed.

If it is determined that printing of the last line of a sheet being printed is not complete (NO in S203), the controller 60 returns the process to S202 and repeatedly executes S202 to S203.

On the other hand, when the controller 60 determines that printing of the last line of a sheet being printed is complete (YES in S203), the controller 60 outputs an instruction to start the ejection characteristic control process to the head controller 50 (S204).

Next, the head controller 50 performs the ejection characteristic control process (S300). That is, while a print job is being executed, the head controller 50 performs the ejection characteristic control process for each page in the interval between the printing times of the pages included in the print job. Note that the ejection characteristic control process will be described in detail later with reference to FIG. 9.

Next, the controller 60 determines whether all the pages included in the print job have been printed (S205).

If it is determined that all the pages have not been printed (NO in S205), the controller 60 returns the process to S202 and repeatedly executes S202 to S205.

On the other hand, if the controller 60 determines that all the pages have been printed (YES in S205), the controller 60 ends the in-printing control process.

Note that in the above description, an operation in which the ejection characteristic control process is performed for each page in the interval between the printing times of the pages has been exemplified, but the present invention is not limited thereto. For example, the ejection characteristic control process may be performed for every several pages in the interval between the printing times of the pages.

### [Procedure of Ejection Characteristic Control Process]

Next, the ejection characteristic control process of the inkjet recording apparatus 1 will be described. In the ejection characteristic control process, the head controller 50 controls the amplitude distribution of the reverberation waveforms of the respective nozzles to fall within a predetermined range. By such control, the ejection characteristics of the plurality of nozzles included in the head 80 are controlled to be uniform. In the present embodiment, the head controller 50 sets a nozzle in which the amplitude of the reverberation waveform falls outside the predetermined range as the target nozzle of the ejection characteristic control process. The head controller 50 controls the ejection characteristics of the plurality of nozzles to be uniform by performing at least one of a process of applying a shaking waveform and a predetermined image correction process on the target nozzle. Here, the predetermined range is a range for determining whether the amplitude distribution of the reverberation waveforms is uniform. The predetermined range varies depending on the accuracy required for the uniformity of the ejection characteristics of the nozzles, the model of the head 80 to be used, the control temperature inside the head 80, and the like.

FIG. 9 is a diagram illustrating a procedure of the ejection characteristic control process of the inkjet recording apparatus 1 according to the present embodiment. The process described below is called and executed as a subroutine in S300 shown in FIGS. 7 and S300 shown in FIG. 8.

First, the drive waveform generator 52 of the head controller 50 generates and sets a drive waveform for reverberation waveform measurement (S301). Furthermore, the drive waveform generator 52 outputs the set drive waveform to the drive circuit 94.

Next, the data output unit 51 outputs image data for the reverberation waveform measurement to the switch controller 821 of the drive IC 82 of the head 80 (S302).

Next, the switch controller 821 of the drive IC 82 couples a nozzle to be measured to the drive circuit 94 to drive the nozzle (S303).

Next, the switch controller 821 of the drive IC 82 switches the nozzle to be measured from the drive circuit 94 to the reverberation waveform receiver 95 and couples the nozzle to the reverberation waveform receiver 95 (S304).

Next, the reverberation waveform receiver 95 of the head controller 50 acquires a reverberation waveform of the nozzle to be measured (S305). In addition, the reverberation waveform receiver 95 outputs the acquired reverberation waveform of the nozzle to be measured to the reverberation waveform detector 53.

Next, the reverberation waveform detector 53 of the head controller 50 measures the amplitude from the reverberation waveform of the nozzle to be measured (S306).

Next, the reverberation waveform detector 53 determines whether the measurement of the amplitudes from the reverberation waveforms of all the nozzles to be measured is complete (S307).

If it is determined that the measurement of the amplitudes from the reverberation waveforms of all the nozzles to be measured is not complete (NO in S307), the reverberation waveform detector 53 returns the process to S303. The reverberation waveform detector 53 repeatedly executes S303 to S307.

On the other hand, if it is determined that the measurement of the amplitudes from the reverberation waveforms of all the nozzles to be measured is complete (YES in S307), the reverberation waveform detector 53 advances the process to S308. In the process of S308, the head controller 50 generates an amplitude distribution of the reverberation waveforms of the measured nozzles.

Next, the head controller 50 determines whether the amplitude distribution of the reverberation waveforms falls within a predetermined range (S309). For example, the predetermined range is set to ±5 mV, which is an amplitude variation range of the reverberation waveform corresponding to a temperature change of the nozzle of about ±1° C. Here, −5 mV is the lower limit value of the predetermined range, and +5 mV is the upper limit value of the predetermined range. When the amplitude distribution of the reverberation waveforms (the amplitudes of the reverberation waveforms of all the nozzles) is within the range of ±5 mV, it is determined that the amplitude distribution of the reverberation waveforms is uniform. That is, it is determined that the ejection characteristics of the nozzles are uniform.

If it is determined that the amplitude distribution of the reverberation waveforms falls outside the predetermined range (NO in S309), the head controller 50 advances the process to S310. In the process of S310, the head controller 50 applies a shaking waveform to the target nozzle when the amplitude of the reverberation waveform of the target nozzle is smaller than the lower limit value of the predetermined range. Applying a shaking waveform makes it possible to control the amplitude of the reverberation waveform of the target nozzle to be within the predetermined range. Here, the shaking waveform is, for example, a waveform having the same waveform as the reverberation waveform and a predetermined amplitude. The nozzle whose reverberation waveform amplitude is smaller than the lower limit of the predetermined range is a nozzle whose temperature is lower than the desired temperature. When the shaking waveform is applied, the temperature of the nozzle having a low temperature increase. The head controller 50 repeatedly applies the shaking waveform until the amplitude of the reverberation waveform of the target nozzle falls within the predetermined range.

Furthermore, in the process of S310, when the amplitude of the reverberation waveform of the target nozzle is larger than the upper limit value of the predetermined range, the head controller 50 performs a predetermined image correction process on the target nozzle. Here, the predetermined image correction process includes at least one of a process of thinning the number of ejections of the target nozzle and a process of reducing the size of the ejected droplets of the target nozzle. The nozzle whose reverberation waveform amplitude is larger than the upper limit value of the predetermined range is a nozzle whose temperature is higher than the desired temperature. When the temperature of the nozzle becomes higher than the desired temperature, the density of the printed image at the position corresponding to the nozzle becomes higher. By performing the predetermined image correction process, the density of the printed image can be corrected to be low. In addition, since the number of ejections or the ejected droplet amount of the target nozzle is reduced by performing the predetermined image correction process, the temperature of the target nozzle is also decreased. Through the process of applying a shaking waveform, the temperature of a nozzle having a low temperature increase. Through the image correction process, the temperature of a nozzle having a high temperature decrease. As a result, the ejection characteristics of the nozzles of the head become uniform. After the process of S310, the head controller 50 returns the process to S302 and repeatedly executes S302 to S309.

On the other hand, if it is determined that the amplitude distribution of the reverberation waveforms falls within the predetermined range (YES in S309), the head controller 50 performs the process in S311. In S311, the head controller 50 selects and sets, based on a control signal from the controller 60, a drive waveform pattern for printing stored in advance. After the process of S311, the head controller 50 ends the ejection characteristic control process.

### [Effects]

As described above, in the inkjet recording apparatus 1 according to the present embodiment, the head controller 50 acquires reverberation waveforms of respective nozzles after the nozzles are driven. The head controller 50 generates an amplitude distribution of the reverberation waveforms of the nozzles from the acquired reverberation waveforms of the respective nozzles. The head controller 50 performs the ejection characteristic control process so that the amplitude distribution of the reverberation waveforms of the nozzles falls within a predetermined range. By performing the ejection characteristic control process, the amplitudes of the reverberation waveforms of the respective nozzles become uniform, and the ejection characteristics of the nozzles also become uniform. Therefore, the inkjet recording apparatus 1 according to the present embodiment can uniformly control the ejection characteristics of the nozzles of the head.

### Second Embodiment

Although the ejection characteristic control process that includes the process of applying a shaking waveform and the predetermined image correction process has been described in the first embodiment, the present invention is not limited thereto. The ejection characteristic control process may be a process of adjusting the drive voltage of the target nozzle such that the amplitude of the reverberation waveform of the target nozzle falls within a predetermined range. In the second embodiment, a control process of the inkjet recording apparatus 1 when the ejection characteristic control process is a process of adjusting the drive voltage will be described. Note that the configuration of the inkjet recording apparatus 1 according to the second embodiment is the same as the configuration of the inkjet recording apparatus 1 according to the first embodiment (see FIGS. 1 to FIG. 4), and therefore, redundant description is omitted. The procedures of the initialization control process and the in-printing control process (see FIG. 7 and FIG. 8) in the second embodiment are also the same as the procedures of the respective processes in the first embodiment, and therefore, redundant descriptions are omitted.

FIG. 10 is a diagram illustrating a drive voltage correction table T10 in the inkjet recording apparatus 1 according to the present embodiment. The drive voltage correction table T10 is a table used for adjusting the drive voltage of a nozzle in the ejection characteristic control process according to the present embodiment. The drive voltage correction table T10 defines correction values for the drive voltage to be applied to a nozzle, corresponding to amplitude correction values for the reverberation waveform of the nozzle. As illustrated in FIG. 10, the drive voltage correction table T10 includes an amplitude correction value column T11 and a drive voltage correction value column T12. The amplitude correction value column T11 stores a correction value, for example, in mV for correcting the amplitude of the reverberation waveform of a nozzle to be within a predetermined range. The drive voltage correction value column T12 stores a correction value of the drive voltage, for example, in units of mV, when the amplitude of the reverberation waveform is corrected with the corresponding amplitude correction value. For example, when the amplitude correction value is “0”, that is, when no correction is made, the drive voltage correction value is also “0”. Furthermore, for example, when the amplitude correction value is “1”, that is, when the amplitude of the current reverberation waveform is corrected to be 1 mV higher, the drive voltage correction value is “50 (mV)”. Note that the example of the drive voltage correction table T10 illustrated in FIG. 10 was arbitrarily created for descriptive purposes. However, the drive voltage correction table T10 to be actually used needs to be acquired by preliminary measurement and registered in the inkjet recording apparatus 1.

FIG. 11 is a diagram illustrating a procedure of the ejection characteristic control process of the inkjet recording apparatus 1 according to the present embodiment. The head controller 50 controls the amplitude distribution to be within a predetermined range by correcting the drive voltage applied to the target nozzle based on the drive voltage correction table T10. The process described below is called and executed as a subroutine in S300 shown in FIGS. 7 and S300 shown in FIG. 8. Furthermore, for the same processes (S301 to S308) illustrated in FIG. 10 as those in FIG. 7, redundant descriptions are omitted.

In the process of S401, the head controller 50 obtains the difference between the amplitude of the reverberation waveform of each nozzle and a predetermined reference value based on the distribution of the amplitudes of the reverberation waveforms. Here, the predetermined reference value varies depending on the accuracy required for the uniformity of the ejection characteristics of the nozzles, the model of the head 80 to be used, the control temperature inside the head 80, and the like. The predetermined reference value is registered in the inkjet recording apparatus 1 in advance.

Next, the head controller 50 obtains an amplitude correction value corresponding to each nozzle for the difference between the amplitude of the reverberation waveform of the nozzle and the predetermined reference value (S402). The head controller 50 takes, for example, the result of rounding off the difference between the amplitude of the reverberation waveform of each nozzle and the predetermined reference value as the amplitude correction value.

Next, the head controller 50 obtains a drive voltage correction value for each nozzle based on the amplitude correction value corresponding to the nozzle and the drive voltage correction table T10 (S403).

Next, the head controller 50 adjusts the drive voltage to each nozzle based on the drive voltage correction value for the nozzle (S404). Further, in this step, the head controller 50 instructs the drive circuit 94 of the value of the corrected drive voltage. Thereafter, the head controller 50 performs the process of S311.

### [Effects]

As described above, in the inkjet recording apparatus 1 according to the present embodiment, the head controller 50 adjusts the drive voltage applied to each nozzle so that the amplitude of the reverberation waveform of the nozzle becomes a predetermined reference value. Therefore, the inkjet recording apparatus 1 according to the present embodiment can also uniformly control the ejection characteristics of the nozzles of the head.

Note that the present invention is not limited to the above-described embodiments. Various other applications and modification examples can be made without departing from the scope of the present invention described in the appended claims.

Each of the embodiments described above is a detailed and specific explanation of the configuration of the inkjet recording apparatus to clearly explain the present invention. However, the present invention is not necessarily limited to those including all the described configurations. Furthermore, a part of the configurations of the embodiments described here can be replaced with a configuration of another embodiment. Furthermore, a configuration of one embodiment may be added to a configuration of another embodiment. Furthermore, it is also possible to add, delete, or replace another configuration for a part of the configuration of each embodiment.

In addition, control lines and information lines considered to be necessary for description are illustrated, and all of the control lines and information lines on a product are not necessarily illustrated. In reality, it may be considered that almost all of the components are coupled to each other.

In the above embodiments, an example has been described in which the amplitude of the reverberation waveform is obtained for each nozzle to generate the amplitude distribution of the reverberation waveforms, but the present invention is not limited thereto. For example, for every predetermined number of adjacent nozzles, the amplitude of the reverberation waveforms may be acquired from one of the adjacent nozzles to generate the amplitude distribution of the reverberation waveforms.

In addition, in each of the above-described embodiments, an example has been described in which the ejection characteristic control process is performed in the interval between the printing times of the pages, but the present invention is not limited thereto. For example, while a print job is being executed, the head controller 50 may perform the ejection characteristic control process on a nozzle corresponding to a non-printing region of each page included in the print job. Here, for example, when image data does not exist over two or more continuous lines at a position corresponding to a nozzle (the image data is a white dot), the position is treated as a non-printing region.

Furthermore, in each of the above-described embodiments, an example has been described in which the process of applying a shaking waveform, the predetermined image correction process and the drive voltage adjustment process are performed to control the amplitude of the reverberation waveform of each nozzle to be uniform. However, the present invention is not limited to this. For example, a plurality of heaters may be disposed at different positions in the head 80. In this case, the head controller 50 may control the heating temperatures of the plurality of heaters so that the amplitude distribution of the reverberation waveforms falls within a predetermined range.

Although embodiments of the present invention have been described and shown in detail, the disclosed embodiments are made for purposes of illustration and example only and not limitation. The scope of the present invention should be interpreted by terms of the appended claims.

What is claimed is:

1. An inkjet recording apparatus comprising:
a head that includes a plurality of nozzles configured to eject ink onto a recording medium;
a drive waveform generator that generates drive waveforms to drive the respective plurality of nozzles;
a reverberation waveform receiver that acquires reverberation waveforms generated in the respective plurality of nozzles to be measured in accordance with the drive waveforms; and
a hardware processor that
generates a characteristic distribution of the acquired reverberation waveforms and
performs, based on the characteristic distribution, an ejection characteristic control process of controlling an ejection characteristic of the plurality of nozzles to be uniform.

2. The inkjet recording apparatus according to claim 1, wherein the characteristic distribution is an amplitude distribution of the reverberation waveforms.

3. The inkjet recording apparatus according to claim 2, wherein the ejection characteristic includes at least one of an ejection speed of the plurality of nozzles and an ejected droplet amount of the plurality of nozzles.

4. The inkjet recording apparatus according to claim 3, wherein in the ejection characteristic control process, the hardware processor controls the amplitude distribution to fall within a predetermined range, thereby controlling the ejection characteristic of the plurality of nozzles to be uniform.

5. The inkjet recording apparatus according to claim 4, wherein, among the plurality of nozzles, the hardware processor
sets a nozzle in which an amplitude of the reverberation waveform falls outside the predetermined range as a target nozzle, and
performs at least one of a process of applying a shaking waveform, a predetermined image correction process, and a process of correcting a drive voltage on the target nozzle, thereby controlling the ejection characteristic of the plurality of nozzles to be uniform.

6. The inkjet recording apparatus according to claim 5, wherein
the shaking waveform has a same waveform as the reverberation waveform and a predetermined amplitude, and
when the amplitude of the reverberation waveform of the target nozzle is smaller than a lower limit value of the predetermined range, the hardware processor performs the process of applying the shaking waveform on the target nozzle, thereby controlling the amplitude of the reverberation waveform of the target nozzle to fall within the predetermined range.

7. The inkjet recording apparatus according to claim 6, wherein when the amplitude of the reverberation waveform of the target nozzle is larger than an upper limit value of the predetermined range, the hardware processor performs the predetermined image correction process on the target nozzle.

8. The inkjet recording apparatus according to claim 7, wherein the predetermined image correction process includes at least one of a process of thinning a number of ejections of the target nozzle and a process of reducing a size of an ejected droplet of the target nozzle.

9. The inkjet recording apparatus according to claim 5, wherein
a drive voltage correction table that defines a correction value of the drive voltage applied to the target nozzle corresponding to an amplitude correction value of the reverberation waveform of the target nozzle is preset, and
the hardware processor performs the process of correcting the drive voltage applied to the target nozzle based on the drive voltage correction table, thereby controlling the amplitude distribution to fall within the predetermined range.

10. The inkjet recording apparatus according to claim 4, wherein
a plurality of heaters is disposed at different positions in the head, and
the hardware processor controls heating temperatures of the plurality of heaters such that the amplitude distribution falls within the predetermined range.

11. The inkjet recording apparatus according to claim 4, wherein, among the plurality of nozzles, the hardware processor excludes a nozzle determined to be a defective nozzle from the ejection characteristic control process.

12. The inkjet recording apparatus according to claim 4, wherein the hardware processor performs the ejection characteristic control process in an initialization process performed when the inkjet recording apparatus is activated.

13. The inkjet recording apparatus according to claim 4, wherein while a print job is being executed, the hardware processor performs the ejection characteristic control process for each page in an interval between printing times of pages included in the print job.

14. The inkjet recording apparatus according to claim 4, wherein while a print job is being executed, the hardware processor performs the ejection characteristic control process on a nozzle, among the plurality of nozzles, corresponding to a non-printing region of each page included in the print job.

15. A method for controlling an inkjet recording apparatus that includes a head including a plurality of nozzles configured to eject ink onto a recording medium, the method comprising:
generating drive waveforms to drive the respective plurality of nozzles;
acquiring reverberation waveforms generated in the respective plurality of nozzles to be measured in accordance with the drive waveforms; and
generating a characteristic distribution of the acquired reverberation waveforms to perform, based on the characteristic distribution, an ejection characteristic control process of controlling an ejection characteristic of the plurality of nozzles to be uniform.
